(19) United States
(12) Patent Application Publication
(10) Pub. No.: US 2006/0110492 A1
(43) Pub. Date: May 25, 2006

(54) Preparation and food product comprising an active phytase

(76) Inventor: Hugo Streekstra, Amsterdam (NL)

Correspondence Address: NIXON & VANDERHYE, PC, 901 NORTH GLEBE ROAD, 11TH FLOOR, ARLINGTON, VA, 22203, US

(21) Appl. No.: 10/543,144

(22) PCT Filed: Feb. 10, 2004
(86) PCT No.: PCT/EP04/01413

§ 371 Date: Jul. 25, 2005

(30) Foreign Application Priority Data
Feb. 11, 2003 (EP) 03100285.0

(51) Int. Cl. A23B 7/10

(52) U.S. Cl. 426/49

(57) ABSTRACT

The invention relates to a preparation comprising an active phytase, a phytate and an essential cation, said preparation being characterized in that at least part of the essential cation is bound to phytate. The preparation may comprise between 1 and 100 FTU phytase per gram phytate, between 1 and 50 g essential cation bound to phytate and between 50 and 99 g of phytate per 100 g of essential cation bound to phytate. The essential cations are selected from the group consisting of calcium, zinc, iron, magnesium, cobalt, molybdenum, manganese, chromium, copper or a combination thereof. The preparation may comprise an additional component such as a chelating agent and/or an antioxidant. The invention also relates to a method for making the preparation of the invention and to its use for making a fortified food product. The invention also relates to a condiment, a cereal product or a soymilk comprising an active phytase.

### FIELD OF THE INVENTION

The invention relates to an edible preparation comprising a phytase, a phytate and an essential cation.

### BACKGROUND OF THE INVENTION

The provision of minerals in a safe and efficacious way is a major challenge in human nutrition. Mineral deficiencies can have a severe impact on metabolic function and human health. Mineral deficiencies are severe, worldwide problems and existing methods of supplementation have failed to solve these. In some countries even an aggravation of the problem could be seen. A number of issues must be addressed (see for instance “The Mineral Fortification of Foods”, R. Hurrell ed., Leatherhead Publishing, Leatherhead, U.K., 1999) to tackle this problem. The main goal in reducing mineral deficiencies is to provide enough bioavailable minerals in a safe and efficacious way. The most bioavailable forms of mineral are often not suitable for inclusion into food, because of their bad taste, and their deleterious effect on the stability of the food. Furthermore although minerals are essential nutrients, serious negative effects may occur when the dosage is too high, due to oxidative damage or the formation of precipitates. Moreover, over-dosing of minerals ultimately promotes their proliferation into the environment, which is increasingly regarded as an undesirable phenomenon. And finally, the bioavailability of the minerals is strongly influenced by other components of the food matrix and the ambient pH-value.

The first issue concerning the bad taste, and the deleterious effect of minerals on the stability of the food, calls for a mineral preparation where the metal ions are shielded, so that they have no effect on taste or food stability. Such preparations exist, for instance the bisglycinates of iron, but their bioavailability is relatively low, and their price is high. The second and third issues relating to overdose and bioavailability are interrelated: the (often unknown) effect of the food matrix makes it difficult to assess the dosage level that is required for a safe, yet efficacious supplementation of the mineral. This is obviously true when the supplementation is performed in the food, but it is also true when the preparation is taken separately, because its uptake will still be dependent on whether food is taken with, before or after the preparation, and on the kind of food. The presence or absence of food components in the gastrointestinal tract together with the mineral will influence its uptake, either via direct interaction, or through their influence on parameters such as gastric pH value, emptying of the stomach, the secretion of bile salts, etc.

Phytate is a food component that is believed to have a particularly strong influence on mineral and/or cation bioavailability (Jovaní et al., Food Sci. Tech. Int. (2001) 7:191-198; Lönnerdal, Int. J. Food Sci. Technol. (2002) 37:749-758). Phytate (or inositol-hexakis-phosphate) is present in many foods of plant origin. The phytate salts of many nutritionally important cations are very poorly soluble. Hence, it is commonly known in the art that the presence of phytate exerts a strong negative effect on the absorption of cations, such as iron (Fe), zinc (Zn), and calcium (Ca). Phytate can be hydrolyzed by the enzyme phytase, which progressively splits off the phosphate groups of the inositol-hexakis-phosphate down to inositol-mono-phosphate (Zimmermann et al., Emährungs-Umschau (2000) 47:423427 and 472476). Methods in the art have already attempted to reduce the phytate levels in food by applying phytase during food processing (Simell et al., Biotechnol. Adv. (1991) 122:145-161). This may be an externally added phytase, the endogenous phytase activity of the foodstuff, or the phytase expressed by microorganisms-during fermentation of the food. The result is a dephytinized food, usually without, or with a low, residual phytase activity. Examples of this technology have been presented for soy protein isolate, for soymilk, for pea flour, for bread dough, and for cereals (Sandberg and Andlid, Int. J. Food Sci. Technol. (2002) 37:823-833). It has even been suggested that partially hydrolyzed phytate may aid in the solubilization of mineral ions (Shen et al., Nutr. Biochem. (1998) 9:298-301).

This method has some disadvantages: (1) It requires a well-controlled step during the food processing, lasting long enough to break-down the phytate in an environment that allows access of the enzyme to the substrate; (2) Although it does reduce the phytate level of the foodstuff at hand, it does nothing about the interaction between minerals and phytates present in the entire food matrix that is consumed.

This problem is partially overcome by adding active phytase to a foodstuff, to achieve the hydrolysis of the phytate in the gut. This is the standard application method for phytase for animal feed (Zimmermann et al., Ernährungs-Umschau (2000) 47:423427 and 472-476) but it has also been shown to work in humans in cereal products (Sandberg et al., J. Nutr. (1996) 126:476-480; Sandberg and Andlid, 2002).

Recently, WO 02/054881 described the addition of Aspergillus niger phytase to milk before pasteurization. Phytase was still active after pasteurization treatment of the milk. Therefore, milk can be used as an effective delivery system of active phytase in food.

A pharmaceutical composition was described in U.S. Pat. No. 4,758,430 patent comprising phytic acid or its salts or hydrolysates as a medicine for the treatment of Alzheimer's disease. The phytate salt is a pharmaceutically acceptable salt such as salts with alkali metal cations or salts with organic bases. The composition may be orally administrated. In this composition, phytic acid is the proposed active ingredient, in which phytase may be present to hydrolyse to lower inositol derivates which could have specific pharmacological effects. Huge quantities of phytate salts, compared to the average daily intake of a population are to be ingested to be effective.

There is still a need for edible food products comprising the desired amount of available minerals without the negative impacts described above. The present invention provides a method to deliver essential cations in an effective and safe way, independent of the endogenous phytate levels of the food. This may be achieved by enriching food with active phytase, in such a way that the phytase is still active in the human gastrointestinal tract, even after prolonged storage of the product. More preferably, this may be achieved by enriching food with both minerals and active phytase. Finally, this can be achieved by means of a preparation, providing simultaneously the essential cations, phytate and phytase. The phytase acts as a liberating principle for the essential cations. Additionally, the nutritional benefits of phytate and partially hydrolyzed phytate are retained.

### DETAILED DESCRIPTION OF THE INVENTION

The present invention relates to a preparation comprising an active phytase, an essential cation, and a phytate, wherein at least part of the essential cation is bound to phytate. Several methods of administration of the preparation are possible. For commodity reasons, the most preferred method of administration is an oral administration, wherein the preparation of the invention is an edible preparation. According to another yet preferred embodiment, the preparation of the invention is such that when it is present in the intestinal tract, essential cations are released from the phytate. This preferred embodiment is realized for example when a fungal phytase is used in the preparation and/or when the phytase is coated to form a slow-release preparation. The preparation of the invention can be in the form of a dietary supplement, which can be ingested before, during or after the meal or which can be added in any food product preferably at the end of its processing. The food product comprising the preparation of the invention is hereafter named a fortified food product. The preparation of the invention and/or the fortified food product of the invention ensure sufficient bioavailability of the essential cations present therein regardless of the amount of phytate present in the food or in the gastrointestinal tract from previously or simultaneously consumed food.

In the context of this application, “a” means “at least one”. Therefore, an active phytase means at least one active phytase, an essential cation at least one essential cation and a phytate at least one phytate.

In the context of this invention, a phytase is an enzyme, which can convert phytate or phytic acid into phosphate and inositol phosphates. Any phytase activity may be used in the present invention, such as for instance: 3-phytase EC 3.1.3.8., 6-Phytase EC 3.1.3.8., or 3,6-Phytase EC 3.1.3.8. According to another embodiment, a mix of several phytases may be used. The phytase of the present invention may e.g. be derived from a microorganism such as a bacterium, a yeast, a fungus or from a plant. Preferably, the phytase is a fungal phytase. In contrast to phytases from plant origin, fungal phytases are also active under acidic conditions, having a high residual activity at pH=2. This makes it possible to hydrolyze the phytate in the stomach, to prevent the subsequent formation of cation-phytate precipitates in the small intestine. More preferably, the phytase is from Aspergillus niger. A phytase from Aspergillus niger has already been commercialized in animal feed and may also be used in the present invention as described in EP 0 420 358 A. Phytase from A. niger is commercialized under the trade name NATUPHOS™. This commercial phytase is available in liquid and solid formulations, and in concentrations of 5000 and 10000 FTU/g. 1 FTU is defined as the amount of enzyme, that liberates one micromole of phosphate per minute from 1 Mm Na-phytate at pH 5.5 at 37° C. The analytical method has been published (Engelen et al, AOAC, Int. 77:760-764 (1994)). Other phytases from A. niger may also be used in the present invention such as the one described in KR 2001003164 A.

The gene encoding the phytase enzyme has been cloned and the phytase enzyme has been over-expressed in Aspergillus niger. Aspergillus niger is grown on industrial scale in large fermenters allowing for the production of the enzyme. The enzyme is secreted in large amounts by Aspergillus niger. Subsequently, the phytase is separated from the biomass in a series of filtration and ultra-filtration steps. The resulting concentrated ultra-filtrate is subsequently formulated into a stable granule or liquid, which may be used in the present invention. Inclusion of the enzyme in specific food products results in hydrolysis of phytate to inositol-rings bearing less phosphate groups and release of essential cations that were associated with phytate. The availability of essential cations present in the food such as iron, calcium, magnesium, phosphorus, zinc, chromium, copper, manganese, molybdenum is therefore improved. At the same time, the protective potential health effect of partially hydrolyzed phytate or inositol is retained. According to another preferred embodiment, the phytase is not a native one, but a phytase enzyme that has been genetically modified in order to have improved properties such as heat stability and/or activity. Such phytases have already been described in the following patent applications EP 0897 010, EP 0 897 985, WO 99/49022 or WO 00/43503. The genetically modified phytases that can be used in the preparation are not limited to these ones.

In the context of the invention, an active phytase is an enzyme preparation capable to convert phytate or phytic acid into phosphate and inositol phosphates. The quantity of active phytase present in the preparation of the invention has to be calculated in order to ensure that a majority of the essential cations bound to phytate would be released from phytate. The needed amount of active phytase can be calculated taking into account the amount of phytate that will have to be hydrolyzed, the time in which this has to occur, the pH-activity-profile of the active phytase chosen, the extent of hydrolysis one wants to achieve and the identity of the essential cations bound to phytate. The preparation of the invention may comprise the following quantities of active phytase. These quantities are given as example: less than 1000 FTU phytase per gram phytate present in the preparation, or less than 500 FTU phytase per gram phytate present in the preparation, or less than 100 FTU phytase per gram phytate present in the preparation, or less than 50 FTU phytase per gram phytate present in the preparation, or less than 20 FTU phytase per gram phytate present in the preparation, or more than 1 FTU phytase per gram phytate present in the preparation, or more than 5 FTU phytase per gram phytate present in the preparation, or more than 10 FTU phytase per gram phytate present in the preparation, or more than 20 FTU phytase per gram phytate present in the preparation, or more than 50 FTU phytase per gram phytate present in the preparation, or more than 100 FTU phytase per gram phytate present in the preparation. Several ranges of active phytase may be present in the preparation of the invention such as for example: between 1 and 1000 FTU phytase per gram phytate present in the preparation, or between 1 and 600 FTU phytase per gram phytate present in the preparation, or between 1 and 300 FTU phytase per gram phytate present in the preparation, or between 10 and 100 FTU phytase per gram phytate present in the preparation. The preparation of the invention is in no way limited to the ranges of phytase activity disclosed in this paragraph. If a higher or a lower phytase activity is needed for a specific application, the person skilled in the art would know how to calculate the needed amount of phytase. A calculation example is given in the examples.

The quantity of essential cation bound to phytate present in the preparation of the invention, and the amount of preparation that the fortified food product of the invention would comprise, may be calculated in order to ensure that the amount of essential cations bound to phytate that would be released from it through the action of phytase would amount to a physiologically acceptable amount. The amount of preparation the fortified food product of the invention may comprise depends on several parameters such as the intake of the essential cation that is recommended according to the normally used definitions such as Recommended Dietary Allowance (RDA), Adequate Intake (AI), Estimated Average Requirement (EAR). Furthermore, the concentration is dependent on the amount of essential cation that binds to the phytate. If the essential cation's valence is one (monovalent cation), the preparation comprises between 1 and 12 essential cations per phytate residue; if the essential cation's valence is two (bivalent cation), the preparation comprises between 1 and 6 essential cations per phytate residue; if the essential cation's valence is three, the preparation comprises between 1 and 4 essential cations per phytate residue. Higher valences are not common in assimilated essential cations but are in no way incompatible with the invention. The concentration is also dependent on the molecular weight of the essential cation itself. Also the phytase content can vary with the application used. The preparation of the invention may comprise the following quantities of essential cations such as for example: more than 1 g essential cation bound to phytate and less than 99 g phytate per 100 g of essential cation bound to phytate, or more than 5 g essential cation bound to phytate and less than 95 g phytate per 100 g of essential cation bound to phytate, or more than 10 g essential cation bound to phytate and less than 90 g phytate per 100 g of essential cation bound to phytate, or more than 20 g essential cation bound to phytate and less than 80 g phytate per 100g of essential cation bound to phytate, or more than 30 g essential cation bound to phytate and less than 70 g phytate per 100 g of essential cation bound to phytate, or more than 40 g essential cation bound to phytate and less than 60 g phytate per 100 g of essential cation bound to phytate, or less than 50 g essential cation bound to phytate and more than 50 g phytate per 100 g of essential cation bound to phytate, or less than 40 g essential cation bound to phytate and more than 60 g phytate per 100 g of essential cation bound to phytate, or less than 30 g essential cation bound to phytate and more than 70 g phytate per 100 g of essential cation bound to phytate, or less than 20 g essential cation bound to phytate and more than 80 g phytate per 100 g of essential cation bound to phytate, or less than 10 g essential cation bound to phytate and more than 90 g phytate per 100 g of essential cation bound to phytate. Several ranges of amount of essential cations may be present in the preparation of the invention such as for example between 1 and 50 g essential cation bound to phytate and between 50 and 99 g phytate per 100 g of essential cation bound to phytate, or between 10 and 45 g essential cation bound to phytate and between 55 and 90 g phytate per 100 g of essential cation bound to phytate, or between 20 and 40 g essential cation bound to phytate and between 60 and 80 g phytate per 100 g of essential cation bound to phytate, or between 25 and 35 g essential cation bound to phytate and between 65 and 75 g phytate per 100 g of essential cation bound to phytate.

The fortified food product of the invention is in no way limited to the examples of amount of preparation given in the above paragraph. If a higher or a lower preparation amount is needed for a specific food product as a result of an adjusted RDA, and/or a change in the quantity of essential cations bound to phytate and/or the molecular weight of the essential cations, the person skilled in the art would know how to calculate the needed amount of preparation. Calculation examples are given in the Examples.

To deliver appropriate amounts of essential cation to the intestinal tract of a human being, eating the preparation of the invention or a fortified food product comprising the preparation of the invention would preferably amount to eat not more than between 1 and 20 mg of phytate/kg of body weight/day. This amount of phytate is in the same order as the amount of phytate normally ingested in a normal daily diet. Preferably, the amount of phytate ingested is ranged between 1 and 15 mg/kg body weight/day, more preferably between 1 and 10 mg/kg body weight/day. The quantities of phytate ingested by eating the preparation or the fortified food product of the invention are in no way limited to the ranges disclosed in this paragraph.

An essential cation is a cation, which is needed for human physiological processes such as the cations of magnesium, iron, zinc, calcium, cobalt, molybdenum, manganese, chromium, and copper. A deficiency in an essential cation could lead to severe diseases. For example, a deficiency in iron could lead to iron deficiency anemia. A deficiency in calcium could lead to osteoporosis. A deficiency in zinc could lead to a lowered immune response and a reduction in linear growth. A deficiency in zinc or iron during pregnancy could lead to impaired brain development of the foetus. According to another preferred embodiment an essential cation is a metal ion. A metal is a chemical element that in general is characterized by the ability to form cations by loss of one or more electrons from each atom.

The preparation according to the invention can be made with any essential cation. Preferably, the essential cation does not inhibit the phytase activity to an extent that it will no longer be active in the intestinal tract. Preferred essential cations are the cations of magnesium, iron, zinc, calcium, cobalt, molybdenum, manganese, chromium, copper or a combination thereof.

In the preparation according to the invention, the essential cations present are such that at least part of them is bound to phytate as their phytate salt. In that way, the availability of the added essential cation is guaranteed by the presence of phytase. The preparation of essential cations bound to phytate has been described previously, for instance in Vasca et al., Anal. Bioanal. Chem. (2002) 374:173-178. At least part of the essential cations means at least 30% of the essential cations, preferably at least 40%, more preferably at least 50%, most preferably at least 60% and even most preferably at least 90%. Even most preferably, no detectable free essential cation is present in the preparation of the invention, as measured in the following standard assay. This assay uses the low solubility of the essential cations bound to phytate compared to other salts of essential cations. For instance, iron phosphate will dissolve at pH=2, whereas iron phytate will not. In strong acids, such as 30% HCl, both salts will dissolve. In general most, if not all, relevant essential cation salts will be more soluble at a given pH value than the phytate salt of the same essential cation.

Alternatively, the assay method used can be the following: a powdered preparation is analyzed via powder X-ray diffractometry. The powder is subjected to x-rays and diffracted x-rays can be examined via the use of a suitable x-ray recorder, which can be x-ray film, one-dimensional x-ray detector, two dimensional area detectors or an electronic x-ray detector or scintillator. In principle x-ray analysis is not limited to the powder form. For example the material to be analyzed may be a number of loose crystals lumped together, twinned crystals or single crystals. Through such methods the spacial relation of the essential cations and the inositol-phosphate rings may be established.

Prolonged calcium-deficiency can lead to severe diseases. It can be a factor in the onset and/or progression of osteoporosis. Calcium-deficiency may be prevented by administering the preparation of the invention, wherein the essential cation is calcium. According to another yet preferred embodiment, when calcium is the essential cation, vitamin D is also present to ensure a maximum quantitative uptake of calcium, as vitamin D, in the form of 1,25 (OH)D₃, stimulates calcium transport across the intestinal cells by inducing the production of a calcium binding protein (CBP). Vitamin D is present in amounts ranging from 1-10 microgram/day. Preferably the amount is between 2-8 micrograms/day, most preferably the amount is between 2.5 and 5 micrograms/day. According to another yet preferred embodiment, the preparation comprises as essential cation calcium and at least one of the following essential cations: magnesium, iron, zinc, cobalt, molybdenum, manganese, chromium, copper. Preferably, when the essential cation is calcium, magnesium is also present as essential cation. More preferably, when the essential cation is calcium, magnesium is present as essential cation as well as vitamin D. This specific preparation is specifically effective as bone mineral formula for optimal bone mineralisation. The combination of these three factors, together with the phosphate groups derived form the hydrolysed phytate, provides a complete bone mineral formula.

Magnesium aids in optimal bone mineralisation and/or aids in the optimalisation of hundreds of enzymatic reactions for which magnesium is a cofactor. Furthermore, magnesium plays an important role in protein and nuclei acid synthesis and has a stabilising and protecting effect on membranes. Magnesium is also considered to be essential in maintaining Ca, K and Na homeostasis. Magnesium-deficiency may be prevented by administering the preparation of the invention, wherein the essential cation is:magnesium. According to another yet preferred embodiment, the preparation comprises as essential cation magnesium and at least one of the following essential cations: calcium, iron, zinc, cobalt, molybdenum, manganese, chromium, copper.

Prolonged iron-deficiency can lead to reduce physical work capacity and productivity and immuno-competence. Iron deficiency can also lead to iron deficiency anemia. Furthermore, reducing iron deficiency during pregnancy reduces the prevalence of prenatal mortality, low birth weight and fetal wastage and aids in improving cognitive functions. Iron-deficiency may be prevented by administering the preparation of the invention, wherein the essential cation is iron. Such a preparation does not have the drawbacks of other known iron supplements such as bad taste. Furthermore, there is a reduced risk of iron overdose, since a specific quantity of iron would be delivered in the intestinal tract. This can be achieved by tuning the phytase activity in the preparation to the desired amount of phytate-bound iron to be released. Finally, for such a preparation, it is very advantageous to adapt the formulation of the preparation to obtain an in-situ delivery system for the essential cation (also named a slow-release preparation). This can be achieved by choosing the formulation so that the phytase would not be active in the stomach but only later on in the intestinal tract. According to another yet preferred embodiment, when iron is the essential cation, vitamin C is also present to ensure a maximum quantitative uptake of iron. Vitamin C enhances the uptake of non-haem iron in the intestine. Vitamin C is preferably present in amounts ranging from 5-95 milligram/day. More preferably the amount is between 15-70 milligram/day, most preferably the amount is between 25-60 milligram/day.

According to another yet preferred embodiment, the preparation comprises as essential cation iron and at least one of the following essential cations: calcium, magnesium, zinc, cobalt, molybdenum, manganese, chromium, copper.

Prolonged zinc-deficiency can lead to severe diseases such as immunodeficiency and diminished linear growth in children. Furthermore, it can lead to skeletal abnormalities and impaired reproductive capacity. Zinc-deficiencies may be prevented by administering the preparation of the invention, wherein the essential cation is zinc. According to another yet preferred embodiment, the preparation comprises as essential cation zinc and at least one of the following essential cations: calcium, magnesium, iron, cobalt, molybdenum, manganese, chromium, copper.

Cobalt-deficiency may be prevented by administering the preparation of the invention, wherein the essential cation is cobalt. According to another yet preferred embodiment, the preparation comprises as essential cation cobalt and at least one of the following essential cations: calcium, magnesium, iron, zinc, molybdenum, manganese, chromium, copper.

As molybdenum is a cofactor in three oxidases enzymes, prolonged molybdenum-deficiency can lead to disturbed metabolic processes such as abnormal sulfur metabolism and developmental and neurological abnormalities. Molybdenum-deficiency may be prevented by administering the preparation of the invention, wherein the essential cation is molybdenum. According to another yet preferred embodiment, the preparation comprises as essential cation molybdenum and at least one of the following essential cations: calcium, magnesium, iron, zinc, cobalt, manganese, chromium, copper.

Prolonged manganese-deficiency could lead to effects such as growth retardation and impaired skeletal development in the fetus. Manganese-deficiency may be prevented by administering the preparation of the invention, wherein the essential cation is manganese. According to another yet preferred embodiment, the preparation comprises as essential cation and at least one of the following essential cations: calcium, magnesium, iron, zinc, molybdenum, cobalt, chromium, copper.

Prolonged chromiun-deficiency can lead to severe diseases such as glucose intolerance. Chromium-deficiency may be prevented by administering the preparation of the invention, wherein the essential cation is chromium. According to another yet preferred embodiment, the preparation comprises as essential cation chromium and at least one of the following essential cations: calcium, magnesium, iron, zinc, molybdenum, cobalt, manganese, copper.

Prolonged copper-deficiency can lead to severe diseases such as anemia with altered iron metabolism and bone marrow changes, impaired immunity with low neutrophil count, skeletal changes with fractures and osteoporosis, hernia and tortuous dilated blood vessels from collagen and elastin cross-linking effects, hair and skin de-pigmentation with steely uncrimpedhair. Copper-deficiency may be prevented by administering the preparation of the invention, wherein the essential cation is copper. According to another yet preferred embodiment, the preparation comprises as essential cation copper and at least one of the following essential cations: calcium, magnesium, iron, zinc, molybdenum, cobalt, manganese, chromium.

Additional components may be included in these formulations, such as chelating agents, to keep the metal ions in solution, and antioxidants, to avoid any residual oxidative stress.

The preparation comprises a phytate, an essential cation, wherein at least part of the essential cation is bound to phytate and a phytase. The physical form of single components may be a liquid, a solid, or a two-phase system (solid in liquid). This applies both to the phytate and the phytase.

Phytate can be in a solid form, when the pure essential cations are bound to phytate (with various essential cation contents, the other counter-ions being hydrogen), or can be present in the form of mixed salts, wherein more than one essential cation is present as counter-ion for the phytate. As an example: using Fe(III), Na+ and H+ as counter ions it is possible to make a Fe-phytate with any desired pH-value (upon mixing with water) and Fe-content. The solid may be made by spontaneous crystallization (which usually gives very fine powder), or by evaporation (which may give a coarser powder). Liquid forms would be the dissolved essential cation bound to phytate in water or buffer. This could be achieved with a mixed salt as just described, at the cost of a relatively low content of the essential mineral.

Mixed forms of phytate would be suspensions or dispersions of the phytate in water or aqueous solutions, for instance a buffer. To make it possible to handle such mixtures, a stabilizer can be added. A good example is xanthan-gum, which forms a gel when in rest (preventing sedimentation of the phytate), but which becomes liquid when poured (allowing dosage of the mixture). This kind of formulation may be useful, because the use of solids is sometimes impractical, for instance when the aim is to coat a solid food.

The phytase may be present in solid forms such as powder (f.i. spray dried, or dried in a multi-stage drier) or granulated forms. Example of food-grade granulation process is to mix a liquid phytase preparation with starch, add moisture to create a dough, extrude the dough, and dry. Phytase can be present in a liquid form such as a stabilized concentrated filtrate. Well-known food-grade stabilizers can be used for this purpose, such as glycerol or sorbitol.

For preparing the preparation of the invention, phytate bound to the essential cation and the phytase may be simply mixed if they are both solid. If phytate bound to the essential cation and the phytase are in a liquid form, it is impossible to mix them, because the enzyme would already start breaking down the phytate in solution. To solve this problem, one could absorb both the phytate bound to essential cation and the phytase to a food component (but different ones). For instance: oat flakes with absorbed phytase and wheat bran with absorbed phytate bound to essential cation could be used to prepare the preparation of the invention and/or a fortified food product comprising a stable cereal food comprising the preparation of the invention. If either phytate bound to an essential cation is liquid and the phytase is solid, or vice versa, the phytate bound to an essential cation must be protected. This may be done by encapsulation of the solid partner, to separate it from the liquid fraction, which may then be absorbed by the coating, or by absorption of the liquid partner by another solid.

The choice of the formulation may influence the application: normally, the phytate will dissolve in the stomach, and the phytase will attack the phytate there. But if either of the two is encapsulated in a way to be released in the gut, they will only come together after the stomach, and this could be considered to be an in-situ-delivery concept (Protein Formulation and delivery, Ed. E. J. McNally, Marcel Dekker Inc, New York, 2000, ISBN 0-8247-7883-9; Handbook of Pharmaceutical Controlled Release Technology, Ed. D. L. Wise, Marcel Dekker Inc. New York, 2000, ISBN 0-8247-0369-3). An in-situ-delivery formulation for lipase has already been described in European patent application EP 913468 A. The whole content of this patent application is incorporated in the present patent application. It means that the coating described for lipase in EP 913468 A can be applied in the present invention to prepare a coating for phytase and/or phytate bound to essential cations.

There are many methods known to the skilled person for preparing phytate bound to an essential cation. Phytate bound to an essential cation can be prepared chemically as described in Vasca et al., Anal. Bioanal. Chem. (2002) 374:173-178. Other publications already described how to chemically prepare Ca-phytate (U.S. Pat. No. 4,070,493, EP 575550B), or Zn-phytate (ES 2007238A). Alternatively, phytate bound to an essential cation can be prepared starting from organic materials. For example, Fe-phytate could be prepared starting from barley phytin (A. B. Stockholms Bryggerier, Swed., Congr. Intern. Inds. Fermentation, Confs. Et communs. (1947) 88-93), Ca-phytate from rice bran (CN 1165142A, EP 409494B), from distillery grains (CN 1050541A) or from steep water (U.S. Pat. No. 3,410,929), Zn-phytate from plant seeds (CN 1055556A). Phytate bound to an essential cation may also be prepared from wheat bran. In this case, an acid extract is made of the wheat bran. Subsequently, the acid extract is titrated with an alkaline metal salt comprising the desired essential cation. Alternatively, the acid phytate extract may first be neutralized, using a strong base, and subsequently soluble salts of one or more essential cations may be added, to achieve precipitation of phytate-bound essential cations. It will be understood that this precipitation may be performed at different ambient pH values, and that this will influence the composition of the resulting essential cation phytate.

The preparation of the invention may be added to any food or drink product for human consumption. Preferably, preparation, storage or subsequent use of the food product does not involve conditions incompatible with phytase activity. In a preferred embodiment, the preparation of the food product does not involve long heat treatments above 100 ° C. and/or the food product does not need to be kept chilled prior to be used and/or does not need to be kept frozen prior to be used. Alternatively, the preparation can be added to the food product at the end of its processing. In that case, preferably only the storage conditions are to be compatible with phytase activity. The food product may be a dry food product. A dry food product is a food product, which may comprise less than 30% water w/w, or less than 25%, or less than 20%, or less than 16%. According to a preferred embodiment, the dry food product comprises cereal. Cereal is an interesting food product since it comprises high amount of phytate. More preferably, the dry food product comprises muesli, rice or pasta or a combination thereof. According to a most preferred embodiment, the cereal is a cereal, which has a phytate content of more than 0.2 mg/100 g cereal. More preferably, the phytate content is more than 0.5 mg/100 g cereal. According to another most preferred embodiment, the dry food product is a cereal bar. According to another preferred embodiment, the dry food product is bread, cake, pastry, flour or a cracker.

According to another preferred embodiment, the product is a drink product. The drink product may be typically formulated for human consumption in terms of taste and look. The drink product may be a flavored drink and may be carbonated. Typically, the drink product is one, which is kept chilled or refrigerated. According to another preferred embodiment, the drink product is a milk. Preferably the milk is cow's milk or soymilk. More preferably, the cow's milk is pasteurized cow 's milk. In that case, the preparation can be added even before the pasteurization step (WO 02/054881); the phytase activity would not be affected by the pasteurization treatment. Alternatively, the drink product may be an instant, dry product, which can be converted into a consumable form by addition of a liquid, such as water or milk. Examples of such drink products are milk powder, instant cocoa drink, or instant orange drink.

According to another preferred embodiment, the food product comprises or is made with milk comprising the preparation of the invention such as cheese, yogurts, milk shakes, creams and desserts, or such as tofu or other soymilk-derived products.

According to another yet preferred embodiment, the food product is a condiment as defined below.

The preparation and fortified food product of the invention can be given to healthy individuals, as part of their normal diet. However, they also could be given to those suffering from mineral deficiencies and may be given to treat, alleviate, or prevent such deficiencies. They may be given to individuals suffering from iron deficiency anemia, or calcium or zinc deficiency. They may also be given as part of the diet of pregnant women or women that recently gave birth.

The present invention further relates to condiments comprising an active phytase. This means that the condiment comprises at the end of its processing a phytase at a concentration of from 5,000 to 1,000,000 FTU/kg, preferably from 10,000 to 500,000 FTU/kg, and most preferably from 50,000 to 150,000 FTU/kg. We surprisingly found that phytase activity is very stable in this type of food products even after prolonged storage at room temperature.

A condiment is a food product usually pungent, acid, salty, or spicy added to or served with food to enhance its flavor or to give added flavor. The condiment can be of natural origin such as pepper, vinegar, and mustard. Alternatively, it could be of any various complex compositions being flavor enhancers such as curry chili powder, chili sauce, fish sauce, pickles, ketchup, tomato sauce, soy sauce. The condiment may also be a more or less pure chemical substance commonly used in food, such as table salt or monosodium glutamate (MSG). Preferably, the condiment is soy sauce or tomato sauce. According to another preferred embodiment, the condiment is supplemented with essential cation such as magnesium, iron, zinc, calcium, cobalt, molybdenum, manganese, chromium, copper or a combination thereof. In that way, the availability of the added minerals is guaranteed by the presence of phytase.

The phytase may be present in solid or liquid forms as described above. The desired quantity of phytase is subsequently added to the condiment.

A condiment is an attractive delivery vehicle for phytase. It usually does not contain significant amount of phytate itself. It is eaten by many people together with various types of food, among which are phytate and/or essential cation rich foods such as (whole grain) pasta, (whole grain) rice, and whole wheat bread.

The present invention further relates to cereal food product comprising an active phytase. Active phytase was already added to a foodstuff, to achieve the hydrolysis of the phytate in the gut. This is the standard application method for phytase for animal feed (Zimmermann et al., Ernährungs-Umschau (2000) 47:423-427 and 472-476) but it has also been shown to work in humans in cereal products (Sandberg et al., J. Nutr. (1996) 126:476-480; Sandberg and Andlid, 2002). These examples of active phytase in human food were all performed in a laboratory setting. The enzyme was added to the foodstuff just prior to consumption. If this was to be translated to a commercial application, this means that the enzyme would have to be provided separate from the food, and added during its preparation. It would be much preferable to provide a food enriched with phytase to the consumer. However, this should be expected to pose problems with respect to the stability of the enzyme, and hence of the shelf life of the product. The present invention demonstrates for the first time the commercial feasibility of such a concept of cereal comprising an active phytase. We demonstrate that an active phytase added to a cereal product remains stable for several weeks. The cereal food product comprises at the end of its processing a phytase at a concentration of from 150 to 30,000 FTU/kg, preferably from 300 to 15,000 FTU/kg, and most preferably from 1,500 to 4,500 FTU/kg. We surprisingly found that phytase activity is very stable in this type of food products even after prolonged storage at room temperature.

More preferably, the cereal food product is muesli, rice or pasta or a combination thereof. According to a most preferred embodiment, the cereal food product is a cereal which has a phytate content of more than 0.2 mg/100 g cereal. More preferably, the cereal food product is a cereal which has a phytate content of more than 0.5 mg/100 g cereal. According to another most preferred embodiment, the cereal food product is a cereal bar. According to another preferred embodiment, the cereal food product is bread, cake, pastry, flour or a cracker.

According to another preferred embodiment, the cereal food product is supplemented with essential cation such as magnesium, iron, zinc, calcium, cobalt, molybdenum, manganese, chromium, copper or a combination thereof. Cereals may comprise huge amount of phytate. Supplementing cereals with essential cations is not always an effective delivery vehicle of essential cation to the person who would eat the cereals, since the essential cations may bind to the endogenous phytate contained in the cereals. In the cereals of the invention, the availability of the added essential cation is guaranteed by the presence of phytase.

The phytase may be present in solid or in liquid forms as described above. The desired quantity of phytase is subsequently added to the cereals.

Cereal food products are an attractive delivery vehicle for phytase. Adding active phytase, preferably at the end of the cereal's processing is a way to deliver enough phytase to work in the intestinal tract when the cereals would be eaten with a meal. Cereal food products are therefore also an attractive delivery vehicle for phytase to reduce the phytate delivered by other components in the food matrix, in addition to the phytate present in the cereal it-self and thereby improve the mineral bioavailability from the minerals present in the entire food matrix.

The present invention further relates to soymilk comprising an active phytase. This means that the soymilk comprises at the end of its processing a phytase at a concentration of from 500 to 20,000 FTU/kg, preferably from 1,000 to 10,000 FTU/kg, and most preferably from 2,000 to 5,000 FTU/kg. We surprisingly found that phytase activity is very stable in this type of food products even after a pasteurization treatment. Soymilk is defined as a mixture of soybean-derived solids and water. This may be prepared by a direct aqueous extraction of processed soybeans. Alternatively, the soybeans may first be fractionated, for instance to obtain a soybean meal or a partly purified soybean protein isolate, and subsequently the fractions may be mixed with water to obtain the soymilk. Various additives may further be added to this milk, such as sources of Calcium and phosphate, flavoring compounds, salt, sugar, etc. Many methods to prepare soybean fractions and soymilk are described in the book Soybean Utilization (Snyder H E and Kwon T W, Van Nostrand Reinhold Comp, New York, 1987). According to another preferred embodiment, the soymilk is supplemented with an essential cation such as magnesium, iron, zinc, calcium, cobalt, molybdenum, manganese, chromium, copper or a combination thereof. In that, way, the availability of the added essential cation is guaranteed by the presence of phytase The phytase may be present in solid or liquid forms as defined above. The desired quantity of phytase may be added at the beginning of the soymilk's processing or may be subsequently added to the soymilk at the end of its processing.

In contrast to cow's milk, soymilk comprises high amounts of phytate. Adding active phytase, preferably at the beginning of the soymilk's processing is a way to diminish its phytate content. At the same time, there would be enough phytase to work in the intestinal tract when the soymilk would be consumed with a phytate rich meal. Soymilk is therefore also an attractive delivery vehicle for phytase to reduce the phytate delivered by other components in the food matrix and thereby improve the mineral bioavailability from the minerals present in the entire food matrix. Adding active phytase, preferably at the end of the soymilk's processing is a way to deliver phytase to reduce the phytate delivered by other components in the food matrix and thereby improve the mineral bioavailability from the minerals present in the entire food matrix.

The invention will further be illustrated by the following examples.

### EXAMPLES

### Example 1

### Calculation of the Amount of Active Phytase Present in the Preparation of the Invention

For instance, 1 FTU will liberate 60 micromoles of phosphate per hour at pH=5.5 and 37° C. If one would want to achieve 50% hydrolysis of phytate, corresponding to the release of 3 phosphate groups per phytate molecule, in 1 hour, 1 FTU would be sufficient for 20 micromoles of phytate (under optimal conditions). If we would use NATUPHOS™, which has residual activity at characteristic stomach pH-values of about 50% of its optimal activity, this number would drop to 10 micromoles, corresponding to 6.6 mg of phytic acid. This is equivalent to 150 FTU per gram phytic acid. The dosage per gram of essential cation bound to phytate will be less, depending on the mass ratios of the cations and the phytic acid. If the cations would consitute 1/3 of the preparation, the dosage would be 100 FTU per gram of essential cation bound phytate.

### Example 2

### Calculation of the Amount of Essential Cation Present in the Preparation of the Invention and the Amount of Preparation the Fortified Food Product of the Invention May Comprise

We below calculated the amount of preparation the fortified food product of the invention may comprise for two examples of essential cations: calcium and chromium. Calcium has been chosen as example of essential cation, since it is the essential cation with the highest Al, whereas chromium is a trace element. The following assumptions are used for calcium:
The AI for women aged 19-30 years is 1000 mg/day (Dietary Reference intakes for Calcium, Phosphorus, Magnesium, Vitamin D and Fluoride. Standing Committee on the Scientific Evaluation of Dietary Reference Intakes. Food and Nutrition Board, Institute of Medicine The National Academy Press Washington D.C., 1997, ISBN 0-309-06350-7 p 71-145)
the phytase content of the preparation is 10% of the phytate content
in the preparation used, 3 mol of Ca have been bound to 1 mol of phytate.

The ranges are calculated in order of preference according to
10-100% AI
15-75% AI
25-50% AI
Under these conditions, the following preferred ranges are found: preferably the fortified food product comprises the preparation of the invention in a concentration, which is ranged between 698-6980 milligrams per 100 grams of fortified food product, more preferably between 1047-5234 milligrams per 100 grams of fortified food product and most preferably between 1745-3490 milligrams per 100 gram of fortified food product.

The following assumptions are used for chromium:
The AI for women aged 19-30 years is 25 microgram/day (Vitamin A, Vitamin K, Arsenic, Boron, Chromium, Copper, Iodine, Iron, Manganese, Molybdenum, Nickel, Silicon, Vanadium and Zinc. Standing Committee on the Scientific Evaluation of Dietary Reference Intakes. Food and Nutrition Board, Institute of Medicine The National Academy Press Washington D.C., 2001 ISBN 0-309-07279-4 p. 197-223).
the phytase content of the preparation is 10% of the phytate content
in the preparation used, 2 mol of Cr have been bound to 1 mol of phytate

The ranges are calculated in order of preference according to
10-100% AI
15-75% AI
25-50% AI

Under these conditions, the following preferred ranges are found: preferably the fortified food product comprises the preparation of the invention in a concentration, which is ranged between 19-199 micrograms per 100 grams of fortified food product, more preferably between 29-145 micrograms per 100 grams of fortified food product and most preferable between 49-100 micrograms per 100 gram of fortified food product

### Example 3

### Preparation of Metal Phytates (PA) and Characterization Thereof.

Ca-phytate (CaPA) and Na-phytate (NaPA) were obtained from Sigma (Catalogue 2002-2003 P 9539 and P 3168, respectively).

Iron-phytate (FePA) was prepared by dissolving Na-phytate in demineralized water and the pH was adjusted to pH=6.3 with 5% acetic acid. and the pH was adjusted to pH=6.3 with 0.9M sulfuric acid. Subsequently, an amount of 0.5M iron(II)sulfate-heptahydrate was added until precipitation occurred. The precipitate was centrifuged and the sediment was washed with 75% water and 25% ethanol. In the second wash step the precipitate was washed with 50% water and 50% ethanol. Finally the pellet was washed twice with 100% ethanol. Subsequently the sediment was freeze-dried. The freeze-dried FePA was analyzed for its moisture and ash content. The iron and phosphorus content were determined by AES/ICP (Atomic Emission Spectroscopy/Inductively Coupled Plasma). The molar ratio of Fe to P was found to be 0.88, which lies between the values characteristic for Fe₅PA (0.83) and Fe₆PA (1.0).

ZnPA and MgPA were prepared in the similar way as FePA, by using the corresponding metal-sulfate. Indeed, this method is suitable for all metal phytates. The molar ratio of Zn to P was found to be 0.89, again lying between the values characteristic for Zn₅PA and Zn₆PA.

### Example 4

### Treatment of Calcium Phytate With Phytase.

The activity of Aspergillus niger phytase (NATUPHOS™) was tested against NaPA and CaPA. The influence of the metal in the phytate source on the phytase activity (37° C. using an incubation time of 60 minutes) was investigated. The rate of phytate hydrolysis was determined using the analytical method described by Engelen et al., J. AOAC Int. 77:760-764 (1994).

The results, expressed as FTU/g, are shown in Table 1.

TABLE 1
Phytase activity on different substrates.

| Substrate | Activity (FTU/g) |
|---|---|
| 5.1 mM sodium phytate | 3.06 * 10⁵ |
| 4.6 mM calcium phytate | 3.12 * 10⁵ |
| 5.1 mM calcium phytate | 3.07 * 10⁵ |
| 5.6 mM calcium phytate | 3.10 * 10⁵ |

The activity of phytase is equivalent on sodium and on calcium phytate.

### Example 5

### Comparative Example

### Mineral and Phytate Release Without Phytase

Various phytate-containing foodstuffs are commercially available. We have used Cruesli™ (Quaker Oats) as a model. The Cruesli™ was ground to a powder, to avoid inhomogeneity problems when sampling. About 20 g of ground Cruesli™ was suspended in 40 g acetate buffer (0.25 M, pH 5.5, 37° C.) or in 40 g diluted HCl (0.08 N, final pH=2, 37° C.). The suspensions were incubated at 37° C. with constant stirring for 1.5 h, and subsequently centrifuged for 20 minutes at 16000 rpm and 4° C. After centrifugation the sediment and the supernatant fraction were separated, weighed and analyzed by AES-ICP to determine their phosphorus, calcium, magnesium and zinc content. The results, expressed in mg, are shown in Table 2:

TABLE 2
Mineral amounts in ground Cruesli ™ fractions after 1.5
hours of incubation at 37° C. at different pH values.

| | Phosphorus | | Calcium | | Magnesium | | Zinc | |
|---|---|---|---|---|---|---|---|---|
| | (mg) | | (mg) | | (mg) | | (mg) | |
| | super- | | super- | | super- | | super- | |
| | natant | pellet | natant | pellet | natant | pellet | natant | Pellet |
| pH | 7.12 | 37.8 | 3.03 | 3.02 | 7.49 | 5.51 | 0.158 | 0.132 |
| 2 | | | | | | | | |
| pH | 13.4 | 29.4 | 1.87 | 4.34 | 4.81 | 8.37 | 0.039 | 0.242 |
| 5.5 | | | | | | | | |

Table 2 shows that the solubility of phosphorus-containing species is higher at pH=5.5 than at pH=2. For the metal ions, it is clear that these are more soluble at the low pH, The solubility at pH=2 may be regarded as the upper limit that may be reached by an effective phytase treatment at higher pH levels.

### Example 6

### Treatment of Phytate-Containing Foodstuffs With Phytase.

Various phytase preparations are commercially available. We have used the liquid formulation NATUPHOS™ 5000 L (DSM, Delft, The Netherlands). Again we used ground Cruesli™ (Quaker Foods & Beverages) as model phytate-containing foodstuff. About 20 grams ground Cruesli™ was suspended in two separate lots of 40 g acetate buffer (0.25 M, pH 5.5, 37° C.). To one of the lots, 1.2 g of the phytase preparation was added, to achieve a final activity of 100 FTU/g. The suspensions were incubated at 37° C. with constant stirring for 1,5 h, and subsequently centrifuged for 20 minutes at 16000 rpm and 4° C. After centrifugation the sediment and the supernatant fraction were separated, weighed and analyzed by AES-ICP to determine their phosphorus, calcium, magnesium and zinc content.

The results, expressed as the percentage of the minerals present in the supernatant fraction, are shown in Table 3:

TABLE 3
Mineral partitioning in ground Cruesli ™ fractions
after 1.5 h of incubation at pH 5.5 at 37° C.,
with or without added phytase activity.

| | Phosphorus | Calcium | Magnesium | Zinc |
|---|---|---|---|---|
| | % of mineral in supernatant fraction | | | |
| pH 5.5 | 31 | 31 | 36 | 14 |
| pH 5.5 phytase 100 FTU/g | 42 | 40 | 49 | 19 |

Table 3 shows that phytase treatment is effective in increasing the solubility of phosphorus and metals at pH=5.5.

### Example 7

### Treatment of Phytate-Containing Foodstuffs With Lower Dosage of Phytase.

The procedure for this example was the same as for Example 6, but a lower final phytase activity in the incubation was used: 1 FTU/g, instead of 100. The incubation time was lowered to 1 hour.

The results, expressed as the percentage of the minerals present in the supernatant fraction, are shown in Table 4:

TABLE 4
Mineral partitioning in ground Cruesli ™ fractions
after 1 h of incubation at pH 5.5 at 37° C.,
with or without added phytase activity.

| | Phosphorus | Calcium | Magnesium | Zinc |
|---|---|---|---|---|
| | % of mineral in supernatant fraction | | | |
| pH 5.5 | 25 | 27 | 30 | 13 |
| pH 5.5 phytase 1 FTU/g | 30 | 30 | 36 | 22 |

Table 4 shows that also a lower dosage of phytase is effective in increasing the solubility of phosphorus and metals at pH=5.5. By comparing the results from Example 7 with Example 6, we see that the effect of the phytase dosage is not linear, suggesting that the accessibility of the substrate is (partly) determining the reaction rate.

### Example 8

### Treatment of Phytate-Containing Foodstuffs at pH=2.

The procedure for this example was the same as for Example 7, but at a lower pH value and a longer incubation time. This was done to simulate the conditions existant in the stomach. We looked specifically at iron, because iron salts are believed to be particularly poorly soluble at higher pH values, making breakdown in the stomach an attractive option. Iron concentrations were determined by AES-ICP. The results, expressed as the percentage of the minerals present in the supernatant fraction, are shown in Table 5:

TABLE 5
Iron and phosphate partitioning in ground Cruesli ™ fractions
after 2 h of incubation at pH 2 at 37° C., with or
without added phytase activity (1 FTU/g).

| | |
|---|---|
| Phosphorus | Iron |

% of mineral in supernatant fraction

| | | |
|---|---|---|
| pH 2 | 14 | 8 |
| pH 2 phytase 1 FTU/g | 33 | 14 |

Table 5 shows that phytase is also effective at lower pH values in increasing the solubility of phosphorus and metal ions.

### Example 9

### Making a Mineral-Phytate-Phytase Preparation

Fe-phytate was prepared according to Example 3. The Fe-phytate was mixed with NATUPHOS™ 5000 G in the proportion of 9:1 (w/w), to achieve a final phytase activity of 500 FTU per gram dry Fe-phytate-phytase preparation.

1 g Ca-phytate (Sigma, Catalogue 2002-2003 P 9539) was suspended in 10 g water. Subsequently, the pH was brought to pH=2 with concentrated HCl, and the suspension was stirred until all Ca-phytate had dissolved. Subsequently, 0.5 g of NATUPHOS™ 5000 L was added, to achieve a final activity of 250 FTU per gram of liquid Ca-phytate-phytase preparation. This preparation has to be used immediately, to avoid premature breakdown of the phytate.

### Example 10

### Addition of the Preparation of the Invention to Cereal and Following of the Action of Phytase Thereon

The Fe-phytate-phytase preparation described in Example 9 was used, using the Fe-phytate from Example 3 and NATUPHOS™ 5000 G (DSM, Delft, The Netherlands). 0.1 g of this preparation was added to 20 g ground Cruesli™ (Quaker Foods & Beverages). Additional NATUPHOS™ was added to achieve a total dosage of 300 FTU per g of the fortified food. Subsequently, the food containing the metal-phytate-phytase preparation was suspended in 40 g diluted HCl (0.08 N, final pH=2, 37° C.), giving a final activity of 100 FTU per g suspension. The suspension was incubated at 37° C. with constant stirring for 4 h, and subsequently centrifuged for 20 minutes at 16000 rpm and 4° C. After centrifugation, the sediment and the supernatant fraction were separated, weighed and analyzed by AES-ICP to determine their phosphorus, calcium, magnesium, zinc and iron content. Control suspensions without phytase activity (but with the FePA), and without both FePA and phytase underwent the same procedure.

TABLE 6
Mineral partitioning in ground Cruesli ™ with added FePA

| | | |
|---|---|---|
| Incubation | Phosphorus | Iron |

| | | | |
|---|---|---|---|
| Phytase | Fe-phytate | | Percentage of mineral in |
| 115 FTU/g | 450 mg/kg | pH | supernatant fraction (%) |

| | | | | |
|---|---|---|---|---|
| − | − | <1 | 60 | 18 |
| − | − | 2 | 13 | 9 |
| − | − | 5.5 | 31 | 7 |
| − | + | <1 | 68 | 23 |
| − | + | 2 | 9.6 | 10 |
| + | + | 2 | 33 | 7 |
| + | − | 5.5 | 45 | 6 |

N.D.: not determined

The data illustrate that it is possible to increase the iron content of a food without a significant decrease in the solubility percentage. This shows that it is possible to increase the availability of a metal ion by providing the metal phytate and phytase in a food matrix.

### Example 11

### Phytase Stability in Soy Sauce

Soy sauce (Kikkoman, Sappemeer, The Netherlands) was used as model foodstuff to determine the stability of NATUPHOS™ (DSM, Delft, The Netherlands). NATUPHOS™ 5000 L was added to Soya sauce to reach a final concentration of 5% (w/w). This suspension was diluted 100-fold in 0.25M acetate buffer (pH=4.8, which is the endogenous pH-value of the Soy sauce), and incubated at 20° C. and 35° C. for 4 weeks. The phytase activity of different time samples was determined using the analytical method described by Engelen et al., J. AOAC Int. 77:760-764 (1994). The results, expressed in mg, are shown in Table 6:

TABLE 7
Phytase stability in soya sauce (1% w/w) at different temperature.

Incubation

| | 20° C. | 35° C. |
|---|---|---|
| Time (weeks) | Activity (FTU/g) | Activity (FTU/g) |
| 0 | 2.63 | 2.63 |
| 2 | 2.59 | 2.35 |
| 4 | 2.59 | 2.21 |

It is clear that phytase is surprisingly stable in this condiment, even at 35° C.

### Example 12

### Phytase Stability in Foodstuffs With and Without Phytate

The stability of phytase in other foodstuffs was also determined. NATUPHOS™ 5000 L, a liquid preparation containing 5000 FTU/g, was added to Oyster Sauce (Lee Kum Kee, Hong Kong, China), Fish Sauce (Pantainorasingh manufacturer, Thailand), Tomato Ketchup (H. J. Heinz, Elst, the Netherlands), and Chilli Sauce (Flower Brand, Ho Chi Minh City, Vietnam) to a final concentration of 1% (w/w) phytase in the condiment. The suspensions were incubated at 20° C. for 3 months. NATUPHOS™ 5000 G, a granulated preparation containing 5000 FTU/g, was added to the grated cheese “Formaggio da Pasta” (Grozette, the Netherlands) to a final concentration of 1% (w/w) and incubated at 20° C. for 3 months. A dry product was made by drying a liquid concentrated phytase suspension in water in a multi-stage drier (final activity 67000 FTU/g). This was mixed with various dry foodstuffs, to a final concentration of about 700 FTU/g, and the phytate-fortified foods were stored at 20° C. for 6 weeks. The following foodstuffs were used: instant Orange Drink Mix, instant chicken soup (Struik Foods Europe), instant cocoa drink (Nesquick, Nestlé), Mild Madras Curry Powder (TRS Wholesale Co. LTD, England), Nido instant Full Cream Milk Powder (Nestlé), wheat flour (Tarwebloem, van Mook Int. Trade Service B. V.), instant binding powder (Allesbinder, H. J. Heinz B. V., Zeist).

The phytase activity of different time samples was determined using the analytical method described by Engelen et al., J. AOAC Int. 77:760-764 (1994). It was found that phytase was surprisingly stable after storage in all of these condiments and foods:

TABLE 8
Residual phytase activity in various foodstuffs

| Food | Residual activity (%) | |
|---|---|---|
| Grated cheese | 92 | (12 weeks) |
| Fish sauce | 96 | (12 weeks) |
| Chili sauce | 74 | (12 weeks) |
| Oyster sauce | 96 | (12 weeks) |
| Tomato ketchup | 90 | (12 weeks) |
| Wheat flour | 85 | (6 weeks) |
| Instant cocoa drink | 96 | (6 weeks) |
| Milk powder | 100 | (6 weeks) |
| Curry powder | 94 | (6 weeks) |
| Instant binding powder | 93 | (6 weeks) |
| Instant chicken soup | 92 | (6 weeks) |
| Instant orange drink | 92 | (6 weeks) |

### Example 13

### Stability of Phytase After Pasteurization in Soymilk and Cow's Milk

NATUPHOS™ 5000L was added to soymilk (Alpro, Izegem, Belgium) and raw cow's milk (obtained from a local farmer, Delft, the Netherlands) to a final concentration of 10 FTU/g. The soymilk was pasteurized during 20 seconds at 85° C.

After addition of NATUPHOS™ to the milks, samples were taken before and after pasteurization to determine the phytase activity according to the analytical method described by Engelen et al., J. AOAC Int. 77:760-764 (1994).

It was found that 78% of the initial phytase activity was retained after this pasteurization treatment in the soymilk, and 84% in the raw cow's milk.

### Example 14

### Method to Determine the Amount of Essential Cation Bound to Phytate

The prepared FePA as described in Example 3 was suspended either at pH 2 or at pH 5,5 in a concentration of 35.8 g per liter. After sedimentation, the supernatant fraction of both suspensions was analysed by AES/ICP. It was found that more than 90% of the Fe was retained in the sedimented fraction at both pH values.

Subsequently, the suspension of pH=2 was centrifuged 10 minutes at 6000 rpm at room temperature. The pellet was dissolved in 15 g concentrated chloric acid and the solution was analyzed by AES/ICP. Now, essentially all Fe could be retrieved in the soluble fraction.

This procedure was repeated with iron phosphate. This salt was prepared in the same way as the preparation of the essential cation phytates: the cation was dissolved as its sulfate, and subsequently precipitated with a basic solution of sodium phosphate. The precipitate was collected and washed. When the iron phosphate was incubated at pH=2 and pH=5.5, it was found that more than 90% of the Fe was retained in the sedimented fraction at pH=5.5, but that less than 10% was retained at pH=2. This provides a clear difference in behaviour for essential cations bound to phytate, compared to their other poorly soluble salts

1. Preparation comprising an active phytase, a phytate and an essential cation, characterized in that at least part of the essential cation is bound to phytate.

2. Preparation according to claim 1, characterized in that, the preparation comprises more than 1 FTU phytase per gram phytate, more than 1 g essential cation bound to phytate and less than 99 g of phytate per 100 g of essential cation bound to phytate.

3. Preparation according to claim 2, characterized in that, the preparation comprises between 1 and 100 FTU phytase per gram phytate, between 1 and 50 g essential cation bound to phytate and between 50 and 99 g of phytate per 100 g of essential cation bound to phytate.

4. Preparation according to claim 1, characterized in that when the preparation is present in the intestinal tract, essential cations are released from the phytate.

5. Preparation according to claim 1, characterized in that the essential cation is selected from the group consisting of calcium, zinc, iron, magnesium, cobalt, molybdenum, manganese, chromium, copper or a combination thereof.

6. Preparation according to claim 1, characterized in that an additional component is present in the preparation, said component being selected from the group consisting of a cheating agent, an antioxidant.

7. Method for making the preparation according to claim 1.

8. Use of the preparation according to claim 1, for making a fortified food product.

9. Food product comprising the preparation of claim 1, characterized in that the food product is selected from the group consisting of muesli, flour, rice, pasta, cereal bar, bread, cake, pastry, cracker, cow milk, soymilk, cheese, yogurts, milk shakes, creams, desserts, condiment.

10. A method of increasing the availability of an essential cation for humans, comprising administering to a human an effective amount the preparation of claim 1.

11. Condiment comprising an active phytase.

12. Condiment according to claim 11, characterized in that the condiment is supplemented with an essential cation.

13. Condiment according to claim 11, characterized in that the condiment is selected from the group consisting of soy sauce, tomato sauce or flavor enhancers such as curry powder.

14. Dry food product comprising an active phytase.

15. Dry food product according to claim 14, characterized in that the dry food product is supplemented with an essential cation.

16. Soymilk comprising an active phytase.

17. Soymilk according to claim 16, characterized in that the soymilk is supplemented with an essential cation.

18. Use of condiment according to claim 11 as a delivery system for phytase in human consumption.

19. Use of dry food product according to claim 14 as a delivery system for phytase in human consumption.

20. Use of soymilk according to claim 16 as a delivery system for phytase in human consumption.

21. A method of increasing the availability of an essential cation for humans, comprising administering to a human an effective amount the food product of claim 9.
